(19) United States
(12) Patent Application Publication
(10) Pub. No.: US 2026/0259079 A1
(43) Pub. Date: Sep. 3, 2026

(54) COMPENSATED PHOTON DETECTOR

(71) Applicant: PsiQuantum, Corp., Palo Alto, CA (US)

(72) Inventors: Avishai Benyamini, Palo Alto, CA (US); Eric F Dudley, Palo Alto, CA (US); Joseph Maria Fargas Cabanillas, Palo Alto, CA (US); Koustuban Ravi, Palo Alto, CA (US)

(21) Appl. No.: 19/149,396

(22) PCT Filed: Jan. 17, 2024
(86) PCT No.: PCT/US2024/011878

§ 371 Date: Jul. 18, 2025

Related U.S. Application Data
(60) Provisional application No. 63/439,824, filed on Jan. 18, 2023.

(51) Int. Cl. G01J 1/44; G01J 1/04

(52) U.S. Cl. CPC G01J 1/44; G01J 1/0425; G01J 2001/442

(57) ABSTRACT

An optical device has an optical detector to detect light from an optical source, an optical returner that receives the light and forms returned light, and an optical coupler that couples the returned light from the optical returner to the optical detector. The optical coupler has a first waveguide and a second waveguide separated by a gap that tapers towards the optical returner, the first waveguide and second waveguide having waveguide walls that are tilted at an angle to a propagation direction along the optical coupler to cancel crosstalk between the first waveguide and the second, waveguide.

### CROSS-REFERENCE TO RELATED APPLICATIONS

This application claims priority from U.S. Provisional Application No. 63/439,824 filed on Jan. 18, 2023, the contents of which are herein incorporated by reference.

### TECHNICAL FIELD

The present disclosure generally relates to optical devices, and more particularly to optical detectors.

### BACKGROUND

Optical detectors can be implemented in optical and electrical devices to detect light for signal processing. It is difficult to implement photodetectors that are sensitive enough to detect individual photons. Single photon detectors can be used in a variety of applications including optical communications and quantum information processing systems.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, or characteristic included in at least one implementation of the inventive subject matter. Thus, phrases such as “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number refer to the figure (“FIG.”) number in which that element or act is first introduced.

FIG. 1 illustrates an example of a qubit entangling system, in accordance with some example embodiments.

FIG. 2 shows a photon number resolving superconducting detector, in accordance with some example embodiments.

FIGS. 3A-3C show operations of a superconducting detector, in accordance with some example embodiments.

FIGS. 4A and 4B show a superconducting detector with an integrated waveguide, in accordance with some example embodiments.

FIG. 5 shows a compensated photon detection architecture with a residual detector, in accordance with some example embodiments.

FIG. 6 shows a compensated photon detection architecture with a residual photon number resolving detection component, in accordance with some example embodiments.

FIG. 7 shows a compensated photon detection architecture with an integrated multi-mode interference coupler, in accordance with some example embodiments.

FIGS. 8A and 8B shows a compensated photon detection architecture with an adiabatic coupler, in accordance with some example embodiments.

FIGS. 9A and 9B shows a compensated photon detection architecture with an angular adiabatic coupler, in accordance with some example embodiments.

FIG. 10 shows a compensated photon detection architecture with a residual detector and an optical splitter, in accordance with some example embodiments.

FIG. 11 shows a flow diagram of a method for implementing a compensated photon detector, in accordance with some example embodiments.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

As discussed, it is difficult to implement photodetectors that are sensitive enough to detect individual photons. Applications that can depend on single photons, such as optical communication systems and quantum information processing (e.g., photonic quantum circuits, photonic quantum computers), can generate a class of specific types of photons that are to be specifically tracked and/or processed across the entire optical system. That is, for example, in optical communication systems that depend on single photons, the single photons may contain optical information that is lost if the single photons are not detected and processed correctly. As an additional example, in a quantum information processing systems that implement single photons, the photons can be used as qubits (e.g., quantum information units of a quantum circuit or quantum computer) which can undergo one or more entanglement and measurement operations to process information. Faulty processing and detection of these photonic qubits can arise due to optical imperfections of the quantum photonic device, which can cause loss of information and failure of a given computation task. The optical errors can be caused by optical loss of the optical components, scattering from rough surfaces of the optical components, scattering or refraction from interfaces between two optical components (e.g., fiber to waveguide coupling), heat causing faulty detection of a photonic qubit when not intended, and a general difficulty of ensuring specific photons all follow a designated and intended path, and do not, for example, refract out a sharp bend in a waveguide path, or leak into a drop port of a coupler due to splitting mismatch in the coupler.

In some photonic quantum systems, such as fault tolerant quantum computer systems, these optical imperfections are “faults” that are corrected via quantum error correction schemes that enable the quantum information processing tasks to successfully complete and return information (e.g., measurement results, output data), even where such faults and imperfections exist in components of the optical system. In such systems, error correction can depend on a physical error rate of the optical system, such as the rate at which specific photons are lost due to the optical error issues described above. As a general example, if 10% of a light beam “leaks” out a sharp bend in a waveguide path, then individual photons (e.g., photonic qubits) that encounter said sharp bend may also leak out of the sharp bend 10% of the time, which can create a physical error rate of the system that limits the use of error correction techniques. Thus, it is essential to limit the optical errors to lower the overall physical error rate for these single photon-based processing systems.

For the forgoing reasons, a compensated photon detector can be implemented that can detect individual photons using multiple passes of a superconducting single photon detector and a residual pass of a residual detector, where an optical mirror can direct the photons towards the detectors for additional passes and detection. In some example embodiments, photons can be generated from an optical source and propagate along a waveguide for detection by superconducting detection elements, which lose their superconductive state when a photon is received and generate a current for detection. In some example embodiments, the photons that are not detected by first detector can be guided to an optical mirror that can redirect the photons back towards the first detector for a second pass and additional detection. In some example embodiments, the optical mirror is formed from a reflective surface, a Bragg grating, or an optical coupler and loop that function in concert as a high efficiency optical mirror.

In some example embodiments, the optical coupler is implemented as a directional coupler, a multi-mode interference coupler, or an adiabatic coupler. The light (e.g., individual photons) can be input into one input port of a coupler and then split 50/50 onto the coupler's output ports, where each of the output ports are coupled to a different input port of a waveguide loop. The input light is then redirected by the waveguide loop and coupled back into the optical coupler as returned light. In a perfect 50/50 split configuration, the light is evenly split by the coupler and 100% is returned into the same input port of the coupler for coupling back to the first detector for a second pass at detection. However, due to component limitations (e.g., manufacturing variations, scattering issues, any defect along the optical processing chain of the device) crosstalk can occur in the coupler amongst different optical modes (e.g., the first mode and second mode) which can cause splitting mismatch to occur between arms of the optical coupler (e.g., an adiabatic coupler). That is, for example, 52% of light may be coupled to the top arm of the coupler and 48% of the light may be split to the bottom arm of the coupler towards the mirror, and as such, on the return path not all the light is redirected towards the first detector, and some of the light may be directed to another port of the coupler.

To minimize splitting mismatch, and in accordance with some example embodiments, the coupler is implemented in the compensated photon detector system as an angular adiabatic coupler that has a taper to adiabatically couple the light and further has varying waveguide wall angles that cancel crosstalk of the unwanted optical modes to achieve high precision even splitting ratio (e.g., 50%±0.1 on to each arm). In this way, more of the light (e.g., individual photons) is statistically sent back to the first superconducting detector for additional detection. In some example embodiments, the first and the second modes in the adiabatic coupler are the dominant modes of the light (e.g., dominant modes of the individual photons), whereas the third mode is poorly guide and can be safely ignored in the photonic design with regard to splitting mismatch. As such, crosstalk between the modes that lead to splitting mismatch are cancelled (e.g., the first and second modes), while crosstalk between the modes that may cause some minimal loss but not splitting mismatch (e.g., the first and third modes, the second and third modes) may still propagate in the coupler and mirror components and still yield high precision splitting ratios.

In some example embodiments, even with a high precision splitting ratio, some individual photons may statistically not be directed back to the first detector and may be directed to another port that is not coupled to the first detector, which functions as a drop port. In some example embodiments, a scatter mitigation structure is formed on the drop port to absorb the light directed to the drop port to ensure the light at the drop port is detected and not scattered out to the photonic circuit, which can cause issues (e.g., unintended scattering towards detector elements. In some example embodiments, the scatter mitigation structure is formed from a same layer of material that is used to form the detector components (e.g., superconducting material, niobate) where the compensated coupler is formed from material of another layer (e.g., Silicon waveguide layer, Silicon Nitride layer).

In some example embodiments, simply coupling light towards the drop port (e.g., even with the drop port absorber scatter mitigation structure added) is not practical in a given photonic design (e.g., extremely low loss photonic designs used in quantum optics), because the likelihood of light still scattering out from the drop port can significantly degrade performance of the photonic circuit. To address the foregoing, and in accordance with some example embodiments, an additional superconducting single photon detector is coupled to the other port of the angular adiabatic coupler for a second pass at detection using the additional superconducting single photon detector to ensure a very high quantity of the photons input into the compensated detector system are tracked and/or processed correctly. In particular, for example, the compensated photon detector can operate at 99.5% efficiency: for each photon that enters the compensated photon detector there is a 99.5% likelihood that it will be detected.

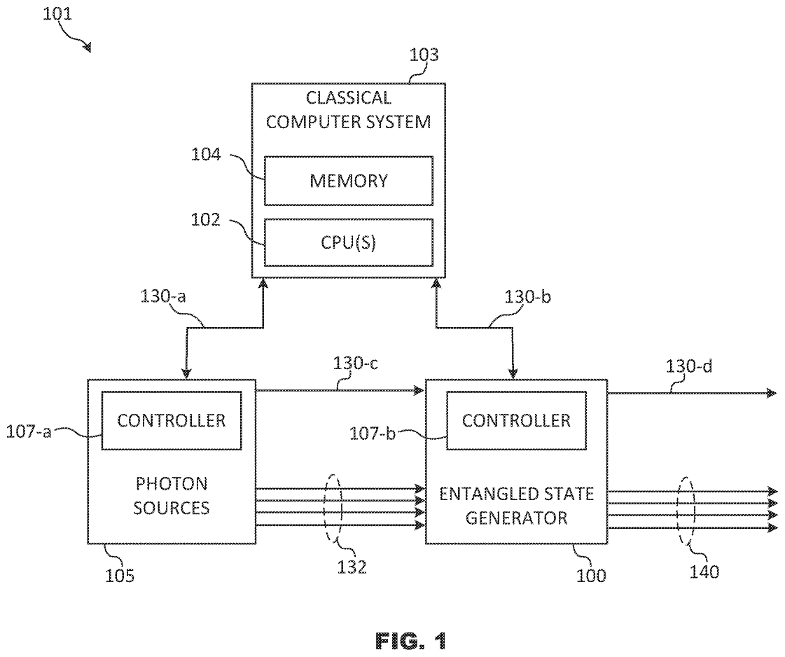

FIG. 1 illustrates an example of a qubit entangling system 101 in accordance with some embodiments. Such a system can be used to generate qubits (e.g., photons) in an entangled state (e.g., a GHZ state, Bell pair, and the like), in accordance with some embodiments. In an illustrative photonic architecture, the qubit entangling system 101 can include a photon source module 105 that is optically connected to an entangled state generator 100. Both the photon source module 105 and the entangled state generator 100 may be coupled to a classical processing system 103 such that the classical processing system 103 can communicate and/or control (e.g., via the classical information channels 130a-b) the photon source module 105 and/or the entangled state generator 100. The photon source module 105 may include a collection of single-photon sources that can provide output photons to entangled state generator 100 by way of interconnecting waveguides 132. The entangled state generator 100 may receive the output photons and convert them to one or more entangled photonic states and then output these entangled photonic states into a plurality of output waveguides 140. In some example embodiments, one or more of the output waveguides 140 are coupled to one or more downstream circuits (not depicted in FIG. 1) that use the entangled states for performing a quantum information processing (e.g., the entangled states are used as resource states for a downstream quantum optical circuit).

In some example embodiments, the system 101 may include classical channels 130 (e.g., classical channels 130-a through 130-d) for interconnecting and providing classical information between components. It should be noted that classical channels 130-a through 130-d need not all be the same. For example, classical channel 130-a through 130-c may comprise a bi-directional communication bus carrying one or more reference signals, e.g., one or more clock signals, one or more control signals, or any other signal that carries classical information, e.g., heralding signals, photon detector readout signals, and the like.

In some example embodiments, classical computer system 103 includes memory 104, one or more processor(s) 102, a power supply, an input/output (I/O) subsystem, and a communication bus or interconnecting these components. The processor(s) 102 may execute applications, programs, and/or instructions stored in memory 104 and thereby perform processing operations.

In some example embodiments, the memory 104 stores one or more programs (e.g., sets of instructions) and/or data structures. For example, in some example embodiments, the entangled state generator 100 generates an entangled state over successive stages, any one of which may be successful in producing the entangled state. In some example embodiments, the memory 104 stores one or more programs for determining whether a given stage of the successive stages was successful and then configures the entangled state generator 100 accordingly (e.g., by configuring the entangled state generator 100 to switch the photons to an output if the stage was successful, or pass the photons to the next stage of the entangled state generator 100 if the stage was not yet successful). To that end, in some example embodiments, the memory 104 stores detection patterns from which the classical computing system 103 may determine whether a stage was successful. In some example embodiments, the memory 104 stores settings that are provided to the various configurable components (e.g., switches) described herein that are configured by setting one or more phase shifts for the component.

In some example embodiments, some or all of the above-described functions may be implemented with hardware circuits on photon source module 105 and/or entangled state generator 100. For example, in some example embodiments, the photon source module 105 includes one or more controllers 107-a (e.g., control circuitry, logic controllers) e.g., which may comprise field programmable gate arrays (FPGAs), application specific integrated circuits (ASICS), a “system on a chip” that includes classical processors and memory, or the like. In some example embodiments, controller 107-a determines whether photon source module 105 was successful (e.g., for a given attempt on a given clock cycle, described below) and outputs a reference signal indicating whether photon source module 105 was successful. For example, in some example embodiments, the controller 107-a outputs a logical high value to classical channel 130-a and/or classical channel 130-c when photon source module 105 is successful and outputs a logical low value to classical channel 130-a and/or classical channel 130-c when photon source module 105 is not successful. In some example embodiments, the output of control 107-a may be used to configure hardware in controller 107-b.

Similarly, in some example embodiments, the entangled state generator 100 includes one or more controllers 107-b (e.g., logical controllers)—which may be implemented using field programmable gate arrays (FPGAs) or application specific integrated circuits (ASICS)—that determine whether a respective stage of entangled state generator 100 has succeeded, followed by performing the switching logic described above, and followed by outputting a reference signal to the classical channels 130-b and/or 130-d to inform other components as to whether the entangled state generator 400 has succeeded.

In some example embodiments, a system clock signal can be provided to the photon source module 105 and the entangled state generator 100 via an external source (not shown) or by the classical computing system 103 generating the signal via classical channels 130-a and/or 130-b. In some example embodiments, the system clock signal that is provided to the photon source module 105 triggers the photon source module 105 to attempt to output one photon per waveguide. In some example embodiments, the system clock signal that is provided to the entangled state generator 100 triggers, or gates, multiple sets of detectors in the entangled state generator 100 to attempt to detect photons. For example, in some example embodiments, triggering a set of detectors in the entangled state generator 100 to attempt to detect photons includes gating the set of detectors.

In some example embodiments, the photon source module 105 and the entangled state generator 100 have integrated internal clocks. For example, the photon source module 105 may have an internal clock generated and/or used by controller 107-a and entangled state generator 100 has an internal clock generated and/or used by controller 107-b. In some example embodiments, the internal clock of photon source module 105 and/or entangled state generator 100 is synchronized to an external clock (e.g., the system clock provided by classical computer system 103) (e.g., through a phase-locked loop). In some example embodiments, any of the internal clocks may themselves be used as the system clock, e.g., an internal clock of the photon source may be distributed to other components in the system and used as the master/system clock.

In some example embodiments, the photon source module 105 includes a plurality of probabilistic photon sources that may be spatially and/or temporally multiplexed to implement a multiplexed single photon source. In one example of such a source, the source is driven by a pump, e.g., a light pulse, which is coupled into an optical resonator that-through a nonlinear process (e.g., spontaneous four wave mixing, second harmonic generation, and the like)—generates zero photons, or one or more photons. In some example embodiments, a respective photon source may be most likely to, on a respective attempt, produce zero photons (e.g., a 90% probability of producing zero photons per attempt to produce a single photon). The second most likely result for an attempt may be production of a single-photon (e.g., a 9% probability of producing a single-photon per attempt to produce a single-photon). The third most likely result for an attempt may be production of two photons (e.g., an approximately 1% probability of producing two photons per attempt to produce a single photon). In some circumstances, there may be less than a 1% probability of producing more than two photons.

In some example embodiments, the apparent efficiency of the photon sources may be increased by using a plurality of single-photon sources and multiplexing the outputs of the plurality of photon sources.

The precise type of photon source used is not critical and any type of source can be used, employing any photon generating process, such as spontaneous four wave mixing (SPFW), spontaneous parametric down-conversion (SPDC). Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. In some examples the photon sources can emit multiple photons that are already in an entangled state in which case the entangled state generator 400 may not be necessary, or alternatively may take the entangled states as input and generate even larger entangled states.

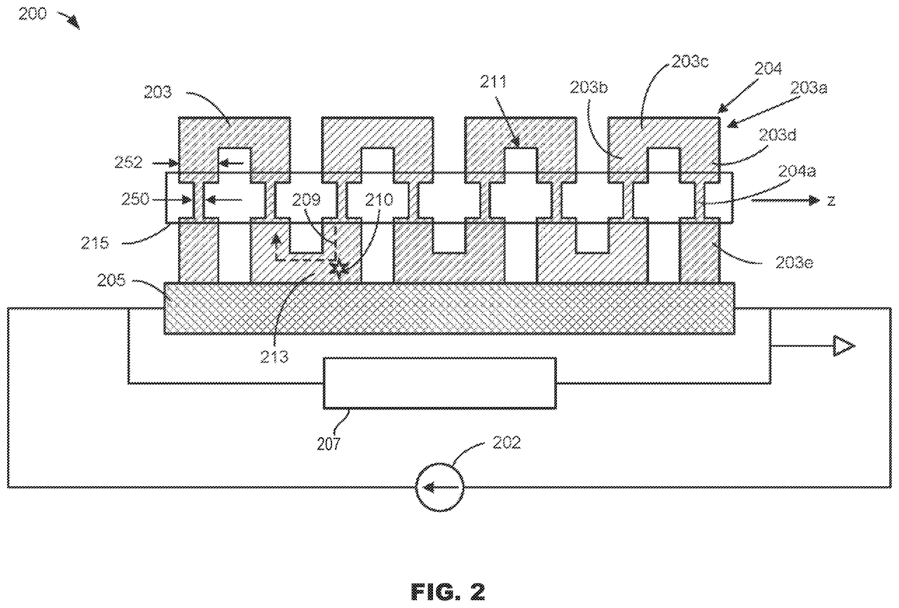

FIG. 2 shows a photon number resolving superconducting (PNRS) detector 200 comprising a plurality of photosensitive superconducting segments that are connected in an electrical series, in accordance with some example embodiments. The photon number resolving superconducting (PNRS) detector 200 is an example photon detector that is used in the photon source module 105, the entangled state generator 100 to detect single photons (e.g., heralded photons) and perform entangled state measurements, in accordance with some example embodiments.

As illustrated, a current source 202 is electrically coupled to a superconducting wire 203 by via metal layer 205 and provides a current to the wire. In some example embodiments, the provided current is below a superconducting critical current level such that the superconducting wire 203 is maintains superconductivity. That is, for example, the level of electrical current supplied by the current source 202 is selected or otherwise provided so as to maintain the superconducting wire 203 in a superconductive state (e.g., zero resistance) absent other conditions (e.g., incident photons). As illustrated, the superconducting wire 203 comprises a plurality of alternating narrow and wide portions, such as a narrow portion 250 and a wide portion 252. In some example embodiments, an optical waveguide is coupled to the plurality of narrow portions of the superconducting wire 203, such as narrow portion 250. In some example embodiments, one or more photons in the optical waveguide impinge one or more of the narrow portions of superconducting wire 203, which results in detection of the one or more photons. In some example embodiments, the narrow portions of the superconducting wire 203 have smaller widths than the wider portions (e.g., the narrow portion 250 has a width of less than 100 nm and the wider portion has a width greater than 150 nm).

In some example embodiments, multiple photons can be detected multiple individual narrow portions of the superconducting wire (e.g., a first narrow portion detects a first photon from the optical waveguide, a second narrow portion detects a second photon, where the first and second narrow portions may be separated by one or more narrow portions or wider portions of the superconducting wire 203). In the example illustrated in FIG. 2, the narrow portions are connected to the wider portions in series using one or more bends in the wider portions, such as the U-shaped bend portion 204, such that direct current flow in superconducting material of the superconducting wire 203 can change directions (e.g., 90 degree direction change, greater than 90 degree direction change in the U-shaped bend portion 204 of a wider portion of the superconducting wire 203).

In some example embodiments, to mitigate current crowding in the superconducting wire 203 (e.g., reduce or avoid current crowding), the narrow portions of the superconducting wire 203 are formed straight (e.g., vertically straight, up-and-down, from the perspective of FIG. 2). In this way, the device is efficient because current changing bends are implemented in the wider portions of the superconducting wire 203 and the narrow portions of the superconducting wire 203 are straight and narrow such that they can be implemented as efficient thin segmented photon sensitive regions that can absorb single photons without causing the entire superconducting wire 203 to lose superconductivity (e.g., transition to a normal non-superconducting state). Additionally, and in accordance with some example embodiments, an absorption of a single photon in one narrow portion does not cause an avalanche effect (e.g., whereby current from a given narrow portion that detects a given photon can bleed or otherwise be diverted to other remaining narrow portions that are still in superconductive states).

Additionally, in this embodiment, the superconducting wire 203 can be formed having a meandering geometry, such that the narrow segments are arrayed along a longitudinal direction (z-direction) of the detector.

In some example embodiments, a metal layer 205 is disposed along an edge of the superconducting wire 203 to provide addressability of each the narrow portion during detection events. In some example embodiments, the metal layer 205 is in parallel with the superconducting wire 203 and forms one or more electrical contacts along the edge of the superconducting wire 203. For instance, in the example of FIG. 2 the metal layer 205 partially overlaps with each U-shaped wider bottom wider portions of the superconducting wire 203; though it is appreciated that in alternative embodiments a metal layer can interface with the top U-shaped wider portions of the superconducting wire 203 (e.g., U-shaped bend portion 204), or a first metal layer can interface with bottom wider portions of the superconducting wire 203 and a second metal layer can interface with the top wider portions of the superconducting wire 203.

In some example embodiments, the metal layer 205 provides parallel electrical resistance across each of the wider leg portions (e.g., in each U-shaped segment), thereby providing a shunting path for current to flow should any of the narrow segments absorb a photon and transition to a non-superconductive state. Additionally, the current can shunt should one or more of the narrow portions become damaged and/or permanently resistive for any reason.

Thus, using the architecture shown in FIG. 2, the resistance of the parallel combination of the metal layer 205 and the meandering superconducting wire 203 varies based on how many narrow segments are in the non-superconducting state (i.e., how many single photons have been absorbed). This effective parallel resistance can then be measured using readout circuit 207, e.g., by measuring a corresponding voltage drop across the length of the metal layer 205 (e.g., the readout circuit is configured to measure the voltage across the electrical contact, which comprises metal layer 205 and is coupled in parallel with the superconducting wire 203).

In some example embodiments, the PNRS detector 200 can be an integrated device with one or more components being disposed on, or in, one or more layers of material, e.g., the device can be formed as a planar integrated circuit. For example, the superconducting wire 203 can be formed from a superconductor layer (e.g., a thin film or the like) that itself can be patterned onto the surface of a substrate layer. As already noted above, the superconductor layer can be formed from any superconducting material that has been deposited onto the substrate layer via any suitable process, e.g., by physical vapor deposition, chemical vapor deposition, atomic layer deposition, and the like. After deposition, the meander geometry can be subsequently patterned via any suitable patterning process, e.g., dry, or wet etching, reactive ion etching, and the like. Likewise, the substrate layer can include any suitable substrate material, e.g., a silicon substrate, a silicon-based substrate (such as a silicon nitride (SiN) substrate) and the like. In some example embodiments, the substrate does not include an oxide layer, so as to reduce or prevent oxidation of the superconducting material layer.

Returning to the example shown in FIG. 2, the meandering shape can be formed from an array of bent (e.g., U-shaped) superconducting structures having alternating orientations and that are each distributed along the longitudinal direction (z-direction) of the PNRS detector 200. Each U-shaped portion of the PNRS detector 200 includes two leg portions that are connected to a base portion. For example, in the embodiment shown in FIG. 2, leg portions 203a and 203b abut a base portion 203c to form an inverted U-shape bend portion 204 (and any number of similar U-shaped portions can be distributed along the z-direction to provide for increased dynamic range, or reliability, of the detector). Furthermore, each leg portion can include a relatively narrow, photon-sensitive central wire segment, each end of which abuts a wider end segment. For example, the leg portion 203a of inverted U-shaped bend portion 204 includes central narrow wire segment 204a, whose upper end abuts wider leg portion 203d and whose lower end abuts wider leg portion 203e.

In the illustrative example shown in FIG. 2, the relatively narrow and straight photosensitive wire segments serve as a series array of single photon detectors that each operate in a manner that is similar to the wire. The narrow segments are electrically coupled to each other via the larger bend segments of the superconducting wire, and these lager bend segments can serve as photon-insensitive buffer regions of the superconducting wire. While the transition in thickness between each narrow central segment and wide arm of each bend segment is shown to be abrupt in FIG. 2, any gradual, tapered transition can be used without departing from the scope of the present disclosure. For example, in some example embodiments, the superconducting wire is tapered between the narrow portions and the wide portions to reduce current crowding effects. In some example embodiments, curved transitions can be employed for the upper/lower bends of the larger U-shape bend regions (e.g., bend region 211), thereby minimizing current crowding phenomena that can be present in superconducting wires having sharp bends.

In addition, the relative sizes of the narrow central segments and the larger buffer regions are chosen such that, at the design wavelength, a single photon can provide enough energy to cause the narrow segment to transition to a non-superconducting state, thereby raising the series resistance of that segment of the superconducting wire. In contrast, any photon that impinges one of the larger buffer regions may not cause that entire region to transition to the non-superconducting state, but rather will create merely a local hotspot. For example, the transverse width (e.g., transverse to the current flow direction) of the thin segments can be approximately, 100 nm or greater and the transverse width of the larger buffer regions can be approximately 150 nm or less. Due to the relatively large area in the buffer region, e.g., buffer region 213, there is sufficient space for the superconducting current 209 to be redistributed around any local hotspots 210 caused by an errant photon absorption. Although in the example of FIG. 2, the hotspots are displayed in a thick bend to illustrate, it is appreciated the hotspots 210 can likewise form in the thin detection area that overlaps the waveguide.

Continuing, thus, even if a photon is absorbed by the buffer regions, the superconducting current can still proceed generally unimpeded down the remaining portion of the device. Furthermore, any local heating present in the central narrow segment can be generally contained within that segment (or can intrude only minimally into the larger width buffer regions), leaving the other, downstream portions of the wire in the superconducting state.

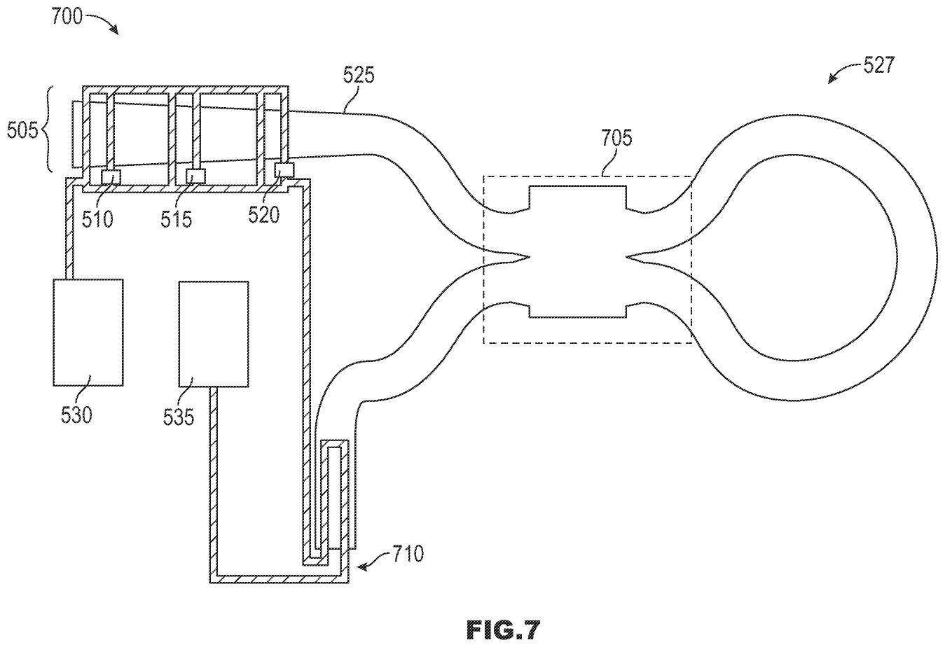

In view of the above, the PNRS detector geometry shown in FIG. 2 can provide for a spatially selective detector that will preferentially detect photons that impinge along the length of the device only (along the z-direction) and will be generally insensitive to photons that are incident on the superconducting wire, if incident in a region that is outside of a relatively narrow region defined by the length of the photo-sensitive narrow segments. In other words, the active region 215 for photon detection for a device having this geometry can be an elongated rectangle, as shown. As described in more detail below, such an arrangement can be advantageous for photon number resolving detection in an integrated optical device such as a linear waveguide. Such detectors can be useful in a number of optical systems, including, e.g., as detectors within heralded photon sources (e.g., as described with reference to FIG. 7) used in a linear optical quantum computer.

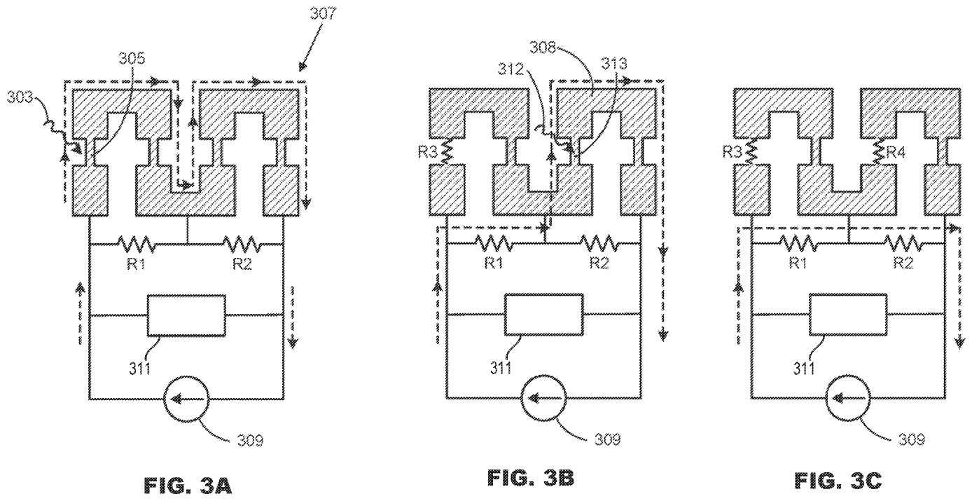

FIGS. 3A-3C illustrate the operation of a portion of the PNRS detector 200 under the case of two incident photons, in accordance with some example embodiments. FIG. 3A shows the state of the detector just before a first photon 303 is absorbed by a first narrow segment 305. Before the photon 303 is absorbed, the entire length of the superconducting wire 307 is in the superconducting state, and therefore the entire (or majority of) current I that is output from the current source 309 passes through the superconducting wire 307 and completely bypasses the resistors R1 and R2. In FIG. 3A, the resistors are shown schematically but in the actual device, these resistors would be formed by a continuous metal layer, e.g., metal layer 205 shown in FIG. 2. As shown, the PRNS detector includes a readout circuit 311 electrically coupled to the superconducting wire 307. The readout circuit 311 is configured to measure an electrical property of the superconducting wire (e.g., a voltage across the superconducting wire 307 or an impedance of the superconducting wire 307). For example, in the state shown in FIG. 3A the output voltage measured by the readout circuit 311 is low, e.g., close to 0 V.

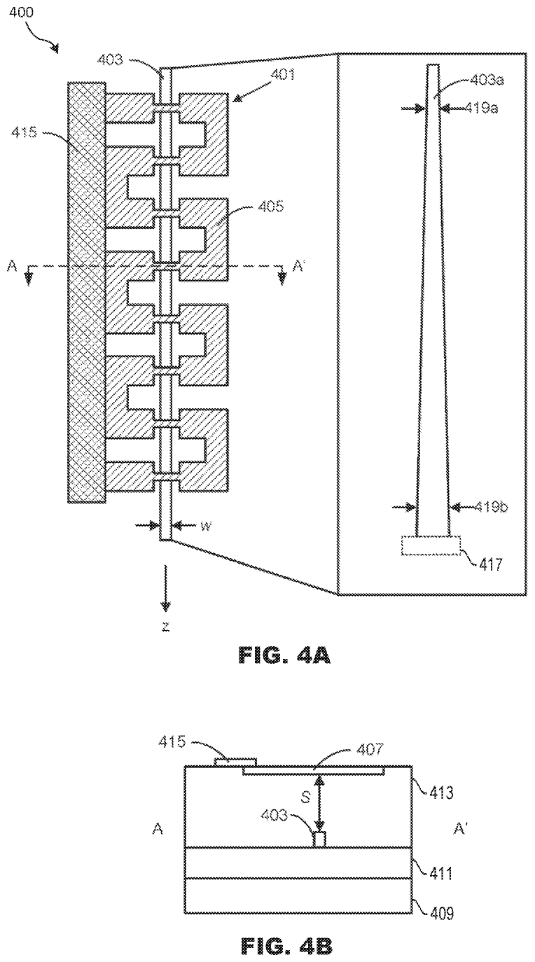

The narrow portions of the superconducting wire 307 are configured to transition from a superconducting (zero resistance) state to a non-superconducting (non-zero resistance) state in response to an incident photon from an optical waveguide (e.g., optical waveguide 403, FIGS. 4A-4B). After the photon 303 is absorbed by the first narrow segment 305, the narrow segment 305 transitions to a resistive normal state (also referred to as a non-superconducting state), and therefore can be represented as a resistor R3, as shown in FIG. 3B. When this occurs (e.g., while narrow segment 305 of the superconducting wire is in a non-superconducting state), the electrical contact has a resistance R1 that is less than a resistance R3 of the superconducting wire 307. Because R3 is much greater than R1, the current I is now forced through R1 and then back into the remaining U-shaped meandering portion 308 of the superconducting wire 307, which is still in a superconducting state. At this point, the voltage drop measured by the readout circuit 311 in this state is I*R1. Shortly after the photon 303 is absorbed, or even simultaneously with the absorption of photon 303, a second photon 312 can be absorbed by a second narrow segment 313. As before, this second narrow segment 313 will transition to the non-superconducting state forming resistor R4, as shown schematically in FIG. 3C. Now, current is forced to pass through both resistors R1 and R2 and thus, the voltage drop measured by the readout circuit 311 in this state is I*(R1+R2).

In view of the above, the PNRS detector can discriminate between a single photon absorption or multiple photon absorptions because the voltage drop at the readout circuit 311 depends on whether one of the narrow segments of a particular U-shape meander has absorbed a photon, transitioned to the normal state, and forced its respective current through its associated shunt resistor. More generally, in a PNRS having m U-shaped meander portions, and resistors R1=R2=Rm=R, if n photons are absorbed by n different photon sensitive segments of the U-shaped meanders, the current is re-routed into n resistors, resulting in an output voltage of ^{~}I*n*R, which is proportional to the number of absorbed photons. In some example embodiments, the number of U-shaped meanders m can be made large compared to the number of photons that are expected to be detected to minimize the chance that any given multi-photon detection will exceed the dynamic range of the detector. In this manner, the electrical property of the superconducting wire 307 measured by the readout circuit 311 (e.g., voltage across the superconducting wire 307) is indicative of a number of photons incident to the superconducting wire 307.

Note that, in some example embodiments, the wide portions are sized so as to remain in the superconducting state regardless of a state of the narrow portions. For example, U-shaped meandering portion 308 remains in a superconducting state regardless of the state of narrow segment 313.

FIG. 4A shows a PNRS detector 401 that has an integrated with an optical waveguide 403, in accordance with some example embodiments. In this example, the PNRS detector 401 can be used to detect photons that are travelling in the optical waveguide 403. In this example, the linear optical waveguide 403 is disposed within a central region of the superconducting wire 405, directly underneath (or above) the array of photo-sensitive wire segments. In some example embodiments, the input of the waveguide can be coupled to a photon source (not shown). Photons generated by the photon source are coupled into the waveguide and eventually arrive at the detector region shown in FIG. 4A. In some example embodiments, the waveguide 403 and the zig-zagging superconducting wire 405 are positioned close enough to each other that it is possible for a photon that is propagating in one of the guided modes of the waveguide to couple out of the waveguide and get absorbed by one of the narrow segments after which it is detected by a readout circuit (not shown), as described above. As shown in the cross section along A-A′ shown in FIG. 4B (not to scale), in some example embodiments, the optical waveguide 403 is vertically stacked with the superconducting layer 407 (e.g., with respect to base substrate 409). Superconducting layer 407 corresponds to superconducting wire 405 in FIG. 4B (e.g., superconducting wire 405 is formed from superconducting layer 407). The separation s between the waveguide 403 and any given narrow segment of superconducting layer 407 is approximately 100 nm or less. This allows for a weak, but non-zero electromagnetic coupling between the guided photons and the photo-sensitive segments of superconducting wire. For example, in some cases the coupling could be on the order of 10% or less per photo-sensitive segment (i.e., the probability of a photon absorption by any given segment is 10%). In such an arrangement, a superconducting wire having 10, 20, 30, 40, 50, or even more photo-sensitive segments may be employed to increase the overall single/multi photon detection efficiency. In addition, because the probability of detecting more than one photon at the same photo-sensitive segment is relatively small, a device such as this can also serve as a PNRS as described above (the photon number is proportional to the number of individual narrow segments that absorb a photon).

The waveguide integrated device shown in FIG. 4A can also be fabricated as a planar integrated circuit, as shown in the cross-section of FIG. 4B. In one embodiment, the base substrate 409 can be a flat silicon wafer. This silicon substrate can be covered by a high-quality silicon oxide layer 411. A waveguide 403 can be formed from silicon and disposed on the surface of the high-quality silicon oxide layer 411, and covered by one or more capping layers, e.g., by a lower-quality silicon oxide layer 413. The superconducting layer 407 that forms the superconducting nanowire is disposed on top of the lower-quality silicon oxide layer 413. A metal layer 415 (e.g., an electrical contact) is disposed on the upper layer of the device, partially overlapping with both the lower-quality silicon oxide layer 413 and the superconducting layer 407.

While the waveguide 403 shown in FIG. 4A has a constant width w, other geometries are possible without departing from the scope of the present disclosure. For example, to compensate for lower detection efficiencies of downstream narrow segments and thus to improve coupling, the optical waveguide is tapered in some example embodiments, such that a downstream portion of the optical waveguide is wider than an upstream portion of the optical waveguide. That is, for example, the waveguide width can increase with increasing length to improve the coupling efficiency of downstream photo-sensitive segments relative to upstream photo-sensitive segments. Tapered waveguide 403a shows one such example (e.g., tapered waveguide 403a has width w that changes along the length of the tapered waveguide 403a, e.g., tapered waveguide 403a has a narrow end 419a and a wide end 419b, which is wider than the narrow end 419a). In the PNRS shown in FIG. 4A, 8 photon-sensitive photo-sensitive segments are used as individual photon detection regions but any number of photo-sensitive segments can be used having any desired coupling efficiency to the waveguide without departing from the scope of the present disclosure. In some example embodiments, PNRS detector 401 includes a mirror 417 disposed at an end of waveguide 403 (e.g., either a straight waveguide 403 or tapered waveguide 403a, although the mirror 417 is shown disposed at an end of tapered waveguide 403a).

In some example embodiments, the mirror 417 is a Bragg mirror. In some example embodiments, the mirror 417 is a retroreflective mirror. In some example embodiments, the mirror 417 is a loop mirror. When the PNRS detector 401 includes the mirror 417, PRNS detector is a “multi-pass” mirror, meaning photons may travel along the waveguide 403 more than once (e.g., travel through the waveguide in one direction, reflect off of mirror 417, and then travel in the opposite direction).

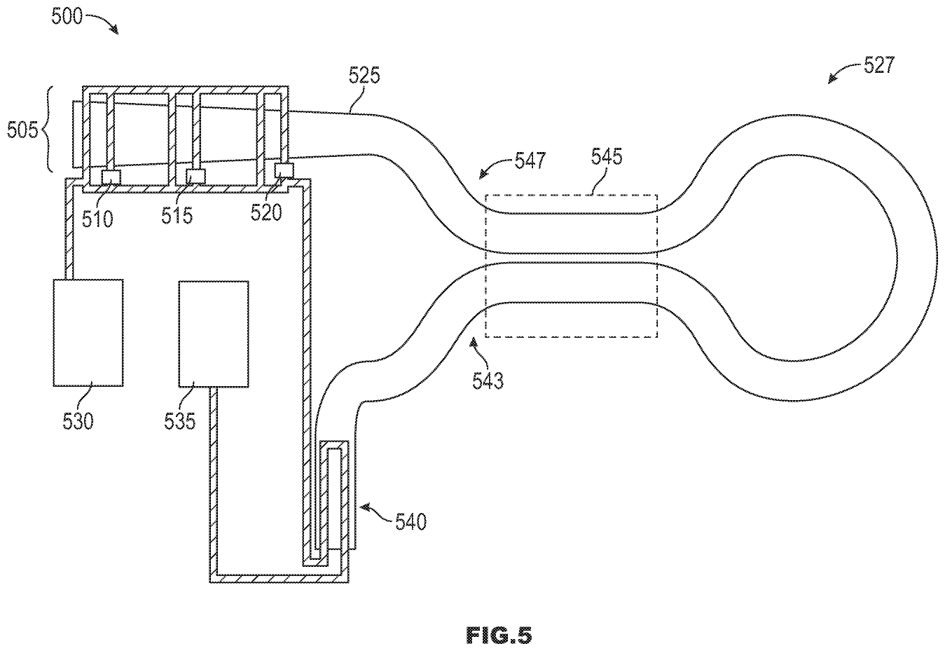

FIG. 5 shows a compensated photon detection architecture 500 with a residual detector to achieve increased optical performance, in accordance with some example embodiments. In the illustrated example of FIG. 5, light from an optical source (e.g., photon source module 105) is input into a photon number resolving detector 505, such as a superconducting nanowire detector (e.g., the PNRS detector 200). The light propagates in a waveguide 525 for detection by the detection elements that lose superconductivity upon photon absorption and further generate a current using one or more resistors, such as resistor 510, resistor 515, and resistor 520. In some example embodiments, the integrated optical components of the compensated photon detection architecture 500 (e.g., the waveguide 525, the optical couplers, the waveguide loop 527) are formed from silicon, silicon nitride, or nitride.

The current generated from the photon number resolving detector 505 is routed via electrical contact, such as an electrical pad 530, to indicate one or more photon detection events (e.g., detection of a heralded photon) for use in processing (e.g., quantum processing of the qubit photons). In some example embodiments, light that is not detected by the photon number resolving detector 505 is coupled to a directional coupler 545 that functions in concert with an optical returning device to function as an optical mirror. For example, the directional coupler 545 is coupled to a waveguide loop 527 to return the light to the photon number resolving detector 505 for a second pass and detection. In some example embodiments, the waveguide loop 527 is fabricated from the same substrate as the other optical components, such as the optical coupler and the waveguides. In some example embodiments, the waveguide loop 527 is formed from a fiber based loop, however it is appreciated that fiber loop (e.g., single mode fiber loop) can greatly increase the loss of the optical path in the compensated photon detector to the point where the loss incurred is greater than the benefits from using residual detectors and high precision optical mirrors.

As illustrated, the directional coupler 545 comprises a pair of optical guides (e.g., waveguides) that are used to combine and/or split optical signals. In some example embodiments, the directional coupler 545 is formed by placing a first waveguide in close proximity to a second waveguide for some parallel length such that light can couple between the two waveguides and light in the two wave guides interferes to direct couple the light to one or more output ports in the desired form (e.g., 50/50 split, 90/10 split, or combined and directed to a single output port). As illustrated, the directional coupler 545 is configured as a 2×2 configuration having two input ports and two output ports.

The amount of light that couples between the two waveguides to the different ports is referred to as the splitting ratio. For example, the directional coupler 545 can be designed as 50/50 power splitter in which 50% of the light input into the directional coupler 545 input is directed to the top output port and 50% of the input light is directed to the other output port (through, power mismatch can occur due to physical parameters, such as manufacturing variations in waveguide roughness scattering). As an additional illustrative example, a directional coupler can be configured as an optical tap to tap a portion of optical signal from a given waveguide. In the optical tap configuration, a large portion of the input light is directed to one output port (e.g., 95%) which is used in per the circuit processing design (e.g., optical modulation, etc.) and a small portion of the input light is directed to the other output port (e.g., 5%) which can be used to test or analyze the light “tapped” at that location of the optical circuit.

Theoretically, where a first waveguide and a second waveguide are in a directional coupler configuration, the light input into a first of the waveguides can couple to the 2nd waveguide completely followed by the light coupling back to the first waveguide in a periodic manner. The coupling coefficient, k, can be used in coupled-mode theory equations (e.g., Maxwells equations constrained to coupled optical guides) to design directional couplers of desired optical performance (e.g., desired coupling ratios) coupling ratios for a given optical circuit design. The coupling coefficient, k, generally depends on the widths of the waveguides, the refractive indices of the materials used to fabricate the waveguides, the optical circuit substrate material, and the gap or proximity of the 2 waveguides along the coupling section of the directional coupler.

In some example embodiments, under ideal conditions, 100% of the light that is input into an input port of the top arm 547 of the directional coupler 545 is split 50% to the output port of the top arm 547 to the waveguide loop 527, and the remaining 50% of the light is directed to the output port of the bottom arm 543 to the waveguide loop 527. The light propagate and counter propagate around the waveguide loops 527 and 100% couple back into the top input port and down the waveguide 525 for additional detector by the photon number resolving detector 505. However, in practice, e.g., due to fabrication, manufacturing, and material defects (e.g., waveguide surface roughness), optical loss and splitting mismatch can occur which cause a mismatch in the splitting ratio.

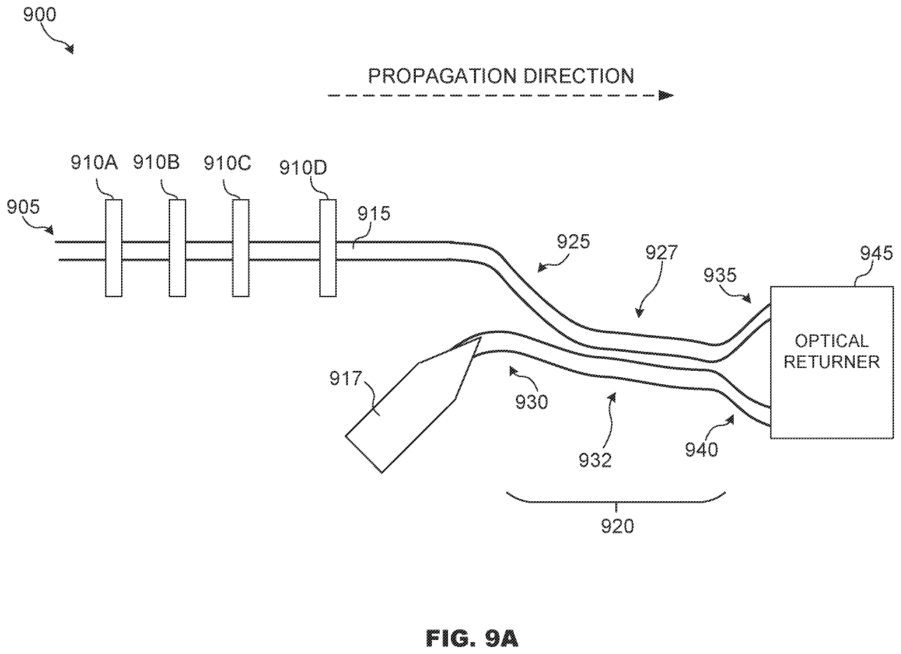

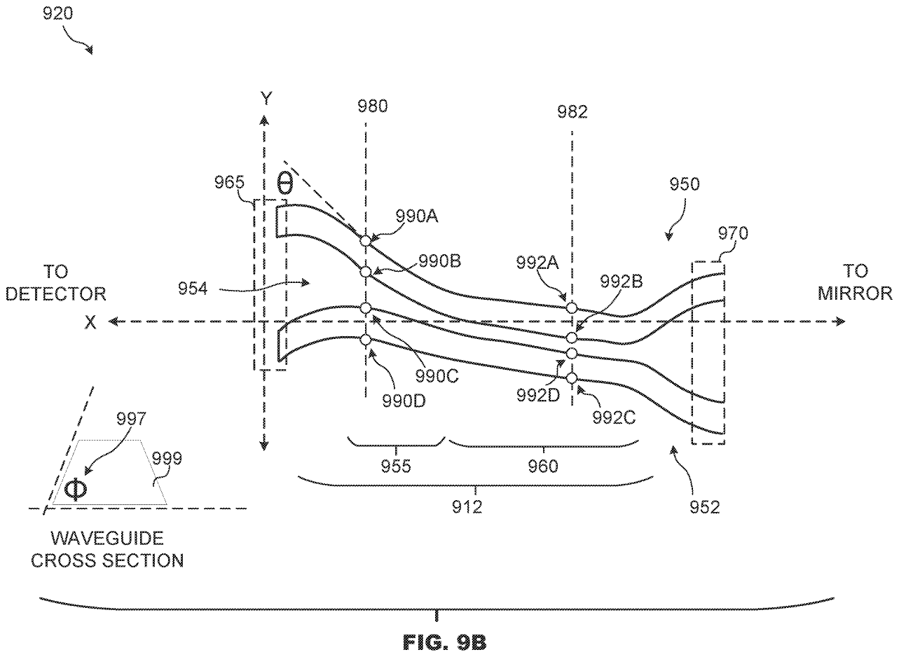

For example, in splitting mismatch, the light is not perfectly split 50/50 between the top arm 547 and the bottom arm 543, and as such not all of the light is coupled back into the waveguide 525 for second pass detection. That is, for example, due to manufacturing variations and material defects of the coupler (e.g., directional coupler 545), the waveguide loop 527, or other components of the compensated photon detection architecture 500, the splitting ratio is not 50/50, but instead 52% on the top arm 547 of the directional coupler 545 and 48% on the bottom arm 543 of the directional coupler 545. In these example embodiments, a small portion of the light can statistically be coupled out from the bottom arm 543 of the directional coupler 545 for detection by a residual detector 540 (e.g., a hairpin configuration detector in FIG. 5), which generates the electrical signal for output to an additional electrical contact, such as the electrical pad 535. As discussed in further detail below with reference to FIGS. 9A and 9B, the splitting ratio mismatch can significantly affect performance of the optical mirror (e.g., the coupler and loop functioning in concert to act as a reflector).

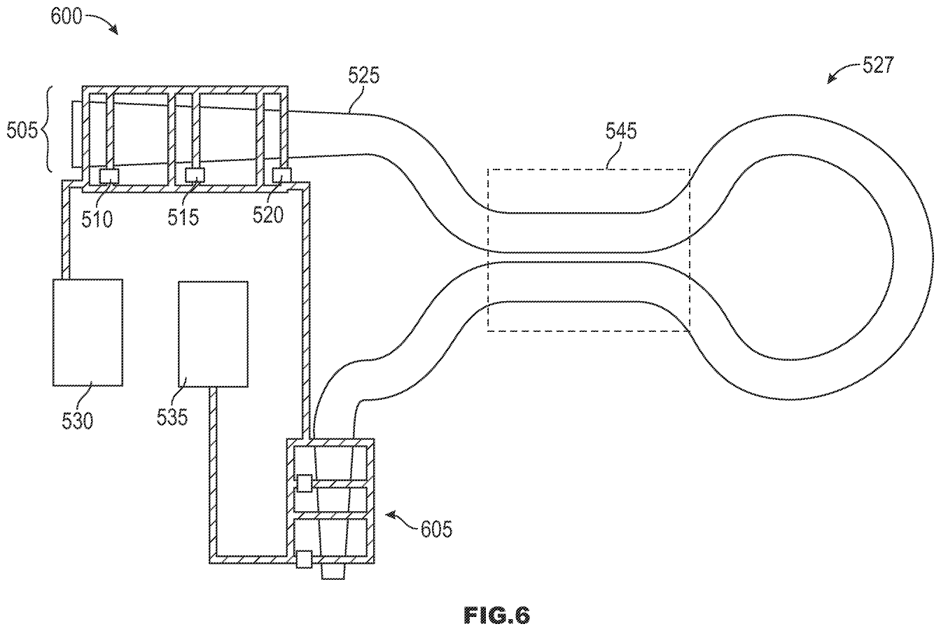

FIG. 6 shows a compensated photon detection architecture 600 with a residual photon number resolving detection component to achieve increased optical performance, in accordance with some example embodiments. In the example illustrated in FIG. 6, the residual detector is implemented as a residual photon number resolving detector to detect light that is leaks from the bottom port of the directional coupler 545 due to splitting mismatch. The residual detector 605 can increase an amount of captured but doubles the footprint of the detection mechanisms and is overall a larger design.

FIG. 7 shows a compensated photon detection architecture 700 that implements a multi-mode interference (MMI) coupler of an optical mirror with a residual detection component to achieve increased optical performance, in accordance with some example embodiments. In the example illustrated in FIG. 7, the coupling element of the optical mirror is implemented as a multi-mode coupler, such as a 2×2 MMI coupler 705. Further, in FIG. 7 the residual detector 710 is implemented as a hairpin detector to detect light that is leaks from the bottom port of the 2×2 MMI coupler 705 due to splitting mismatch. Due to the design characteristics and fabrication techniques for manufacturing MMI couplers in PICs, the 2×2 MMI coupler 705 may yield a more precise 50/50 splitting ratio than the directional coupler embodiments, however MMI splitters are generally not as low-loss across a broadband as other couplers, which can cause photons of some wavelengths to perform poorly when passed through an MMI coupler in an optical mirror configuration.

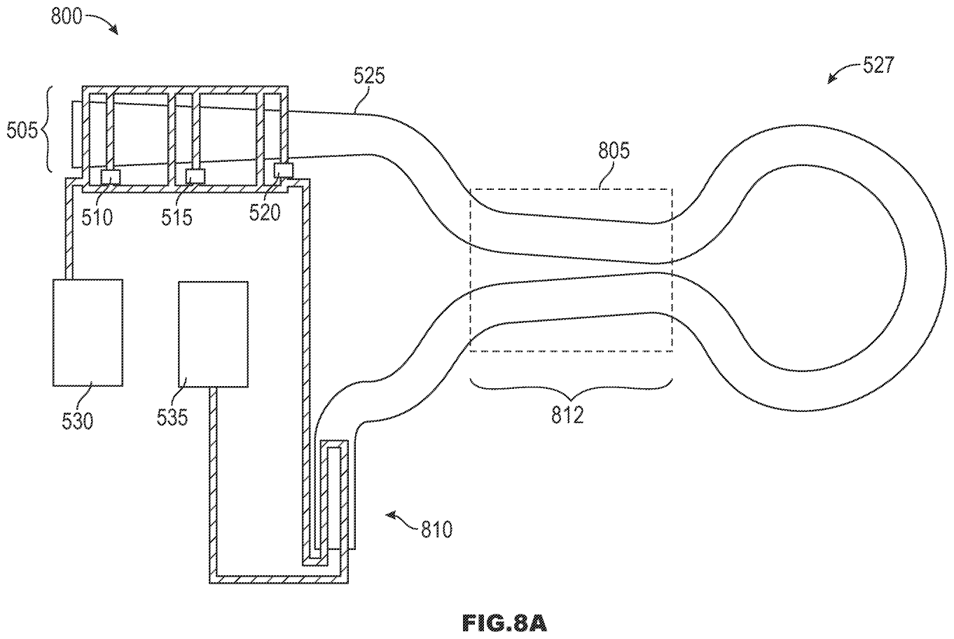

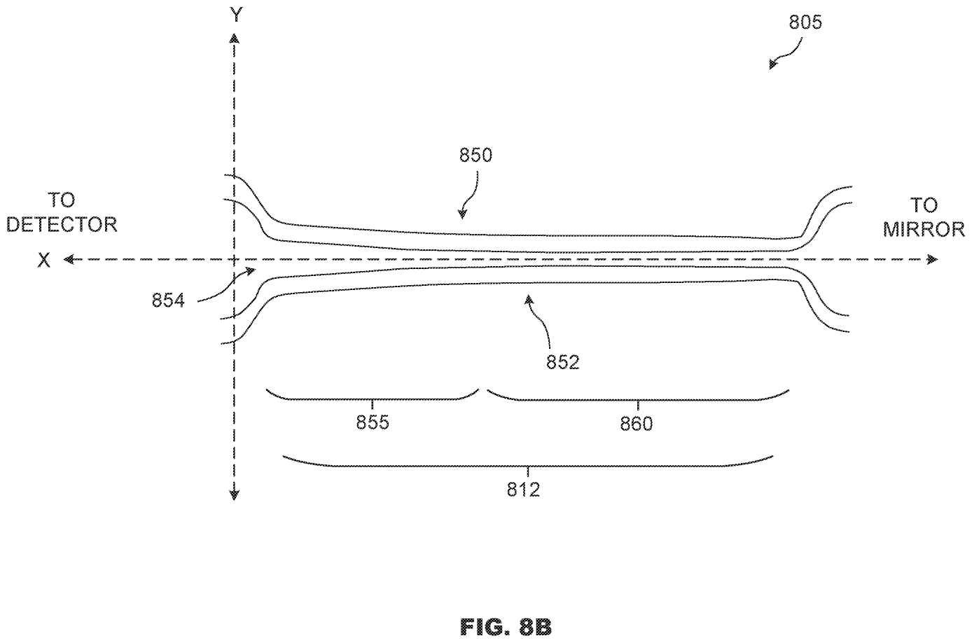

FIG. 8A shows a compensated photon detection architecture 800 that implements an adiabatic coupler of an optical mirror with a photon number resolving detection component to achieve increased optical performance, in accordance with some example embodiments.

In FIG. 8A, the residual detector is implemented as a photon number resolving detector 810 to detect light that is leaks from the bottom port of the adiabatic coupler 805 due to splitting mismatch. The adiabatic coupler 805 is a tapered directional coupler (e.g., tapered waveguide widths, tapered gap between the waveguides) in which the tapers vary slowly enough along the propagation direction such that there is little power exchange between the super modes to reduce coupling to higher order modes. In contrast to directional couplers and MMI devices, which rely on interference parameters to effectuate coupling, an adiabatic coupler uses mode evolution to transfer light from an input port to split the light onto two output ports. Due to the conservation of energy, crosstalk between the two waveguides will exist but can be reduced by increasing the length 812 of the tapered coupling region of the adiabatic coupler along the direction of propagation. However, increasing the length 812 of an adiabatic coupler to increase performance can become impractical in compact quantum optics devices, such as those necessary to scale to create a fault tolerant computer.

FIG. 8B shows a close-up of the adiabatic coupler 805, in accordance with some example embodiments. In the illustrated example of FIG. 8B, light input from the detector to the adiabatic coupler 805 along a propagation direction or axis, such as the X-axis, and the light exits to the optical mirror along that same propagation direction or axis (e.g., normal to a vertical or cross-sectional direction, Y-axis). As illustrated, the adiabatic coupler 805 comprises an upper waveguide 850 (e.g., that is coupled to waveguide 525 to receive light) and a lower waveguide 852. The upper waveguide 850 and the lower waveguide 852 are tapered along a propagation direction (X-axis) so that the light undergoes slow mode evolution to adiabatically transform the light from the upper waveguide 850 and the lower waveguide 852 to the mirror such that a 50/50 split occurs. For example, half of the light exits the upper waveguide 850 to the optical mirror, and the remaining half of the input light exits the lower waveguide 852 to the optical mirror; although, as discussed, due to variations, defects and optical loss, an exact 50/50 split may not occur and light and instead the split may be 51/49 or 52/48, and so on. In some example embodiments, the adiabatic coupler adiabatically or “slowly” transfers light from the input side (e.g., from the detector) to the output side (e.g., to the mirror) and vice versa (e.g., returned light is adiabatically transferred via from the output side to the input side). As used here, the slowness refers to the rate of change of the tapering along the propagation direction (e.g., X-axis). In particular, for example, in a first coupling region 855 the upper waveguide 850 is narrower than the lower waveguide 852, and in a second coupling region 860 the upper waveguide 850 and the lower waveguide 852 have the same width (or vice versa, in accordance with some example embodiments). In the illustrated example, the gap 854 between the upper waveguide 850 and the lower waveguide 852 is tapered along the length 812 of the adiabatic coupler 805. While the adiabatic coupler 805 can reduce mismatch by increasing its length 812, it may be possible in a given photonic circuit design to practically increase the length 812 of the adiabatic coupler 805 and significant splitting mismatch will still occur for high performance single photon detectors.

FIG. 9A shows a compensated photon detector architecture 900 having an angular adiabatic coupler to compensate for splitting ratio mismatch in the optical mirror, in accordance with some example embodiments. In some example embodiments, the compensated photon detector architecture 900 is formed in a photonic integrated circuit from a single substrate, while in other example embodiments, the compensated photon detector architecture 900 comprises multiple chips (e.g., a photonic integrated circuit that is electrically connected to an ASIC).

In the illustrated example, light from a light source (e.g., photon source module 105, FIG. 1) is input into an input port 905 (e.g., fiber coupler, fiber to PIC edge coupler, grating, micro-lens) of a waveguide 915 that propagates the received light near a photon detection element 910A, photon detection element 910B, photon detection element 910C, photon detection element 910D (e.g., superconducting single photon nanowires) to detect one or more photons of the received light. As discussed above, in some example embodiments upon any of the photo detection elements detecting a photon, the given photon detecting element can lose its superconducting properties to provide an indication of the detected photon. In some example embodiments, some or all of the light (e.g., individual photons) is not detected by any of the detection elements 910A-910D and is coupled to an angular adiabatic coupler 920 (e.g., a rapid adiabatic coupler) that is configured to provide a high precision splitting ratio between the upper and lower ports. For example, the splitting ratio can be as high as 50% plus or minus 0.1% which satisfies the optical requirements of sensitive quantum optic devices (e.g., a high quantum efficiency photonic circuit, a fault tolerant quantum computer).

In some example embodiments, the angular adiabatic coupler 920 implements a vertical tilt of the waveguide walls along the propagation direction (e.g., vertical in the perspective in FIG. 9A, where vertical is orthogonal to the “propagation direction”), where the vertical tilt cancels crosstalk of the modes that cause power mismatch along the entire length 912 of the angular adiabatic coupler 920. In this way, light that is split using the angular adiabatic coupler 920 is angularly adiabatically coupled along the entire length 912 of the angular adiabatic coupler 920.

In some example embodiments, input light that is not detected by the plurality of detectors (e.g., detectors 910A-910) are coupled into a top port 925 and is angularly adiabatically coupled between the top arm 927 and the bottom arm 932 of the angular adiabatic coupler 920. The coupled light emanates out from other ports of the angular adiabatic coupler 920 such as the top port 935 and a bottom port 940 into an optical returner 945. In some example embodiments, the optical returner 945 is an optical mirror device that receives the light from the angular adiabatic coupler 920 and returns the light back into the angular adiabatic coupler 920 for additional detection events (e.g., the light is directed back towards top port 925, for a second pass under the plurality of detectors 910A-910D).

In some example embodiments, the optical returner 945 comprises a waveguide loop (e.g., silicon strip or rib waveguide, nitride strip or rib waveguide). In some example embodiments, the optical returner 945 is a simple reflective surface (e.g., metallic surface) that reflects light back to the angular adiabatic coupler 920, or a Bragg grating. Although the examples shown here illustrate the coupler of the optical mirror in direct contact with the returner element (e.g., loop), it is appreciated that one or more additional optical elements can be integrated between the coupler and the returner to facilitate coupling between the former and latter. In particular, for example, the top port 935 and the bottom port 940 can both be coupled to additional respective integrated waveguides that undergo gradual turns (e.g., right turns, left turns, s-bends) to connect to the input ports of the optical returner 945, which may be much wider in size to avoid optical loss.

The light returned from the optical returner 945 is then coupled and angularly adiabatically split to the top port 925 in the bottom port 930. In some example embodiments, due to a precise photonic integrated circuit design with high precision splitting performed by the angular adiabatic coupler 920, effectively all of the light that is received through the top port 925 propagates through the angular adiabatic coupler 920 and through the optical returner 945 is adiabatically coupled back into the top port 925 for coupling to the detection elements 910A-910B. In some example embodiments, due to manufacturing variations of individual PICs, the splitting ratio is not perfect and there is a splitting ratio mismatch in which a small portion is statistically guided towards the bottom port 930 (e.g., a drop port).

FIG. 9B shows a close-up of the angular adiabatic coupler 920, in accordance with some example embodiments. In the illustrated example of FIG. 9B, light is input from the detector to the angular adiabatic coupler 920 along a propagation direction or axis, such as the X-axis (e.g., normal to the cross-sectional access, Y-axis), and the light exits to the optical mirror along that same propagation direction or axis (e.g., normal to the cross-sectional axis, Y-axis). As illustrated, the angular adiabatic coupler 920 comprises an upper waveguide 950 (e.g., that is coupled to waveguide 525 to receive light) and a lower waveguide 952. In some example embodiments, the angular adiabatic coupler 920 varies the waveguide tilt vertically along the length 912 of the adiabatic coupler (e.g., vary the waveguide widths, vertical location, vertical gap location and size, along the length 912). According to some example embodiments, in a first coupling region 955 the upper waveguide 950 is narrower than the lower waveguide 952, and in a second coupling region 960 the upper waveguide 950 and the lower waveguide 952 have the same width (or vice versa, in accordance with some example embodiments).

In contrast to the adiabatic coupler (e.g., FIG. 8B), the angular adiabatic coupler 920 of FIGS. 9A and 9B varies the waveguide widths and their gap 954 vertically along the length 912 of the propagation direction such that crosstalk between unwanted modes in the waveguides is eliminated. In particular, the unwanted mode crosstalk (e.g., crosstalk between the first mode and second mode) can be avoided by engineering the vertical tilt of the waveguide walls to set the local mode coupling coefficient (e.g., k₁₂) between the unwanted modes to zero, thereby ensuring little to no crosstalk occurs between those unwanted modes. For example, with reference to cross section 980, there are four wall point 990A, 990B, 990C, 990D angles (indicated as circles in FIG. 9B) that are evaluated in the design to ensure that each wall is at an angle to the X-axis (e.g., propagation direction) to ensure the unwanted mode crosstalk is eliminated. In the illustrated example, a circle is shown for a given wall point angle, but it is appreciated that the tilt of the wall corresponds to a tangent line extending from the wall point, where the tangent line is at an angle “θ” to the propagation direction, as illustrated with reference to the wall point 990A.

In some example embodiments, the angle or tilt of the respective walls may change constantly along the length 912 of the angular adiabatic coupler 920. For example, a plurality of wall points 992A, 992B, 992C, 992D at cross section 982 may have different angles (than the points of cross section 980) to ensure coupling coefficient of the unwanted modes is set to zero at that cross section as well, and as discussed in further detail below.

In some example embodiments, the wall angles of the respective walls of the respective waveguides can be varied by varying the width of the upper waveguide 950 or the lower waveguide 952, varying the gap 954 between the waveguides, and the cross-section wall angle along each infinitesimal cross section along the length 912 of the angular adiabatic coupler 920. The last parameter (e.g., cross section wall angle or attitude with respect to the X-axis) can be implemented by directing a given waveguide “downward” as illustrated in FIG. 9B by the input region 965 (e.g., an input portion) being vertically offset and higher than the output region 970 (e.g., output portion), thereby providing for a global tilt along the length 912 of the angular adiabatic coupler 920. For example, while the gap 854 taper of FIG. 8B tapers horizontally (e.g., along the propagation axis, X-axis), the gap 954 taper in FIG. 9B tapers at an angle to the propagation axis that can vary along the length 912 of the adiabatic coupler 920 but still provide a taper for the waveguides as the gap 954 distance narrows towards the optical mirror side of the angular adiabatic coupler 920. To further clarify, here, vertical tilt does not mean waveguide side-wall tilt (e.g., the angle Φ 997) of a given-side wall tilting-in, for example, to form a trapezoid-type waveguide cross section 999 (where light in that example propagates within the area enclosed by the trapezoid shape of waveguide cross section 999). Rather, vertical tilt is along L, from left to right in FIG. 9B (e.g., placements of points 990A-990D and 992A-992D are solved as discussed below such that a global vertical tilt along length 912 causes mode cancellation of unwanted modes), in accordance with some example embodiments.

In some example embodiments, a local-modes coupled mode scheme is implemented in designing a given angular adiabatic coupler to determine a requisite vertical tilt for each of the four-waveguide wall points along the length 912. In particular, for example, the following equation is set to zero and solved for each cross section along x:

$${κ}_{mn} ( x ) = \frac{ω}{4} \frac{1}{{β}_{m} ( x ) - {β}_{n} ( x )} \int {\overline{e}}_{tm}^{*} \cdot \frac{\partial ϵ ( x , y , z )}{\partial x} {\overline{e}}_{tn} dzdy$$

In the above, the κₘₙ is coupling coefficient between the unwanted modes (e.g., κ₁₂, for the first and second mode), which is set to zero to denote the condition in which crosstalk between the two modes is to be removed (e.g., eliminated, cancelled). Further, the ω is the frequency, eₜₘ and eₜₙ are the electric fields of the modes n and m, and βₘ and βₙ are the propagation constants of the modes.

With the crosstalk set to zero, the above can be solved for €, the dielectric permittivity distribution caused from the shape of the structure, including additive contributions of the four wall slope values (e.g., ∂/∂x being slope) at a given point of a cross section (e.g., cross section at x₀). In some example embodiments, the angular adiabatic coupler 920 is fabricated according to the determined wall angles for a given design using photonic integrated circuit fabrication techniques, such as maskless lithography (e.g., optical lithography, electron beam lithography).

In this way, the vertically tilted waveguides (e.g., waveguide widths and gap vertical tilt along L), the angular adiabatic coupler 920 is configured as a high precision power splitter in a 50/50 configuration that is accurate to high precision 0.1±% in the architecture 900 of FIG. 9A. That is, in particular, in the given coupler to optical mirror configuration, the angular adiabatic coupler 920 functions with the optical returner 945 to ensure the crosstalk caused from manufacturing variations is eliminated from the PIC design and most of the photons (e.g., 99.9%) are returned to the top port 925 for second pass detection.

In some example embodiments, optical absorption material is formed to create a scatter mitigator 917 that absorbs any errant photons into the material of the absorber. That is, in some example embodiments, one or more photons may still reach the drop port and not be redirected to the detector. In those example embodiments, the photons are directed into the scatter mitigator 917 where the photons are absorbed by the material of the scatter mitigator 917. While errant photons from the port may be re-routed or scattered into a certain direction (e.g., away from the detector), the scatter mitigator 917 results in a more compact detector design that is optically efficient and effectively reduces scatter of photons via complete absorption into the material of scatter mitigator 917 (e.g., Niobium Nitride). In some example embodiments, such as the embodiment illustrated in FIG. 9A, the scatter mitigator 917 is formed during layer processing of the same layer used for form detector components (e.g., material used to form the detectors 910A-910D) and can be formed at the same stage or process (e.g., application of detection material). In this way, the scatter mitigator 917 implements a taper of very high absorption material to reduce overall errant photon scattering and overall optical efficiency of the photon detector architecture 900. Further, although in the example of FIG. 9A illustrates a scatter mitigator 917 having a taper on a drop-port of a waveguide, it is appreciated that in some example embodiments, the taper of the scatter mitigations is linear or an arbitrary shape that is congruent to a given lay out design of the photonic circuit. Further, in some example embodiments, the scatter mitigator can be used and integrated in other photonic circuits to terminate waveguides, such as terminating ports in a ring resonator, a filter, other PIC waveguides, and so on.

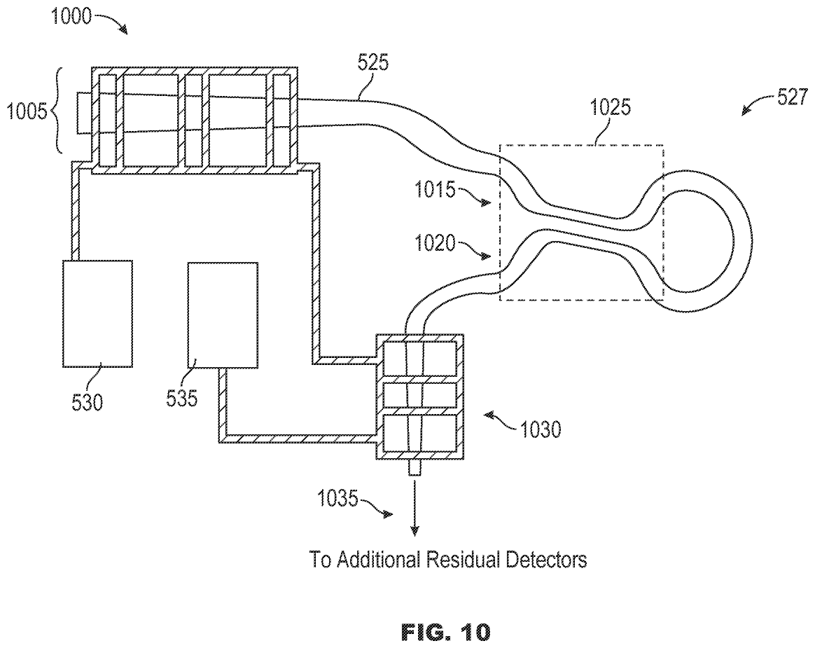

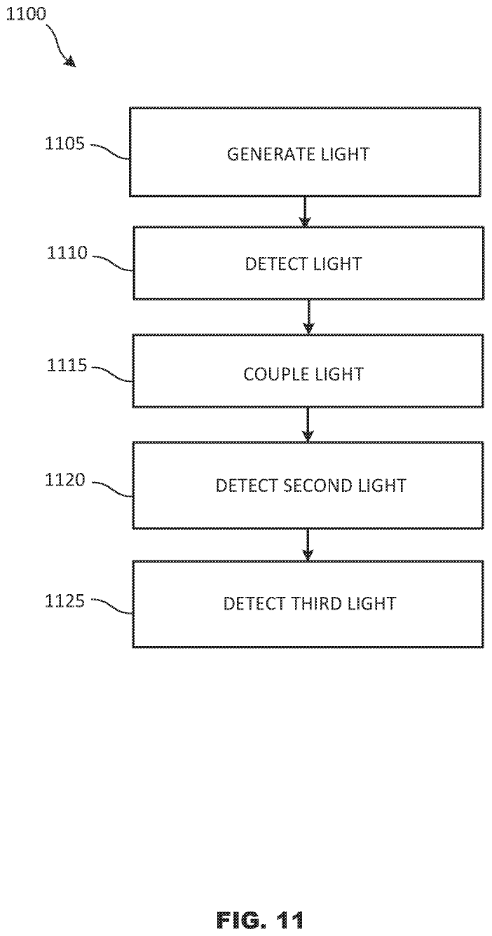

FIG. 10 shows a compensated photon detection architecture 1000 with a residual component and a high precision optical splitter, in accordance with some example embodiments. In the illustrated example of FIG. 10, light from an optical source (e.g., pump laser, not depicted) is input into a first superconducting photon detector 1005, such as a superconducting nanowire in a hairpin or photon number resolving configuration, as discussed above. The light propagates in the waveguide 525 for detection by the detection elements that lose superconductivity upon photon absorption and further generate a current (e.g., via one or more resistive elements). The current generated from the first detector 1005 is then directed to an electrical contact, such as an electrical pad 530, to indicate one or more photon detection events for use in processing (e.g., quantum processing of the qubit photons). In some example embodiments, light that is not detected by the first superconducting photon detector is coupled to a high-precision optical splitter, such as an angular adiabatic coupler 1025 having a precise splitting ratio that is consistent even where manufacturing variations occur in fabrication of the compensated photon detection architecture 1000. The angular adiabatic coupler 1025 is configured to function in concert with an optical return device, such as a waveguide loop 527 or Bragg grating, to form returned light to the first superconducting photon detector 1005 (e.g., receive light from the interface ports of the waveguide loop 527 and return the light as returned light to the interface ports). In some example embodiments, the angular adiabatic coupler 1025 while precise still may have a splitting ratio mismatch in which the light is not perfectly split 50/50 between the top arm 1015 and the bottom arm 1020 of the angular adiabatic coupler 1025, and as such, all of the light may not be coupled back into the waveguide 525 for second pass detection.

That is, the splitting ratio of the angular adiabatic coupler 1025 may not be 50/50, but instead 50.01% on the top arm 1015 of the coupler 1025 and 49.99% on the bottom arm 1020 of the angular adiabatic coupler 1025. In these example embodiments, a statistically small fraction of the light (e.g., photons) is coupled from the bottom port of the bottom arm 1020 of the angular adiabatic coupler 1025 for detection by a residual detector 1030, such as a superconducting nanowire in a hairpin or photon number resolving configuration, as discussed above. Further, in some example embodiments, light that is not detected by the residual detector 1030 (e.g., second superconducting photon detector) and passes through the residual detector 1030 and is coupled to additional residual detectors 1035 (not depicted in FIG. 10), such as a third and fourth superconducting photon detectors connected by optical guides (e.g., integrated waveguides, fibers) to further increase optical performance of the compensated photon detection architecture 1000.

FIG. 11 shows a flow diagram of a method 1100 for implementing a compensated photon detector, in accordance with some example embodiments.

At operation 1105, an optical source generates light. For example, at operation 1105, the photon source module 105 generates a plurality of photons for use as photonic qubits in the qubit system 101.

At operation 1110, a photon detector detects the light. For example, at operation 1110, the individual photons from the photon source module 105 are input into a waveguide 525 and passed close by an initial photon detector, such as the photon number resolving detector 505 or the first superconducting photon detector 1005 for detection. In some example embodiments, the compensated photon detector is implemented in the photon source module 105 to indicate that photons of a given type are generated (e.g., photon pair). Additionally, the compensated photon detector can be implemented in the entangled state generator 100 to detect and/or measure the photons to create entangled photon states.

At operation 1115, the individual photons that are not detected are coupled into an optical coupler, such as a directional coupler, a MMI coupler, an adiabatic coupler, or an angular adiabatic coupler. In some example embodiments, the optical coupler is coupled to a loop or mirror that received the input light to form returned light that is directed towards the initial detector and/or the residual detector.

At operation 1120, the light returned from the coupler and mirror configuration are detected by the initial detector as a second light (e.g., individual photons undergoing a second pass event of the initial detector). For example, the optical coupler of operation 1115 directs a given individual photon towards the initial photon detector (e.g., the photon number resolving detector 505 or the first superconducting photon detector 1005) for a second pass at detection using the initial photon detector.

At operation 1125, the light that is detected by a residual detector (e.g., individual photons undergoing a third pass event of the residential detector). For example, while the couplers implement high precision splitting ratios, some of the photons may still leak out of a port of the coupler a fraction of the time that may overall affect the physical error rate. In these example embodiments, the leaked photons are directed by the coupler (e.g., angular adiabatic coupler) and one or more waveguides to a residual detector for detection and processing (e.g., in a photonic quantum circuit, in a photonic quantum computer).

The following are example embodiments:
Example 1. An optical device comprising: an optical detector to detect light from an optical source; an optical returner that receives the light and forms returned light; and an optical coupler that couples the returned light form the optical returner to the optical detector, the light being coupled into the optical coupler from the optical detector along a propagation direction, the returned light being coupled into the optical detector, the optical coupler comprising a first waveguide and a second waveguide separated by a gap that tapers towards the optical returner, the first waveguide and second waveguide having waveguide walls that are tilted at an angle to the propagation direction along the optical coupler to cancel crosstalk between the first waveguide and the second waveguide.
Example 2. The optical device of example 1, wherein the gap tapers at the angle to the propagation direction.
Example 3. The optical device of example 1 or 2, wherein the optical coupler comprises an input portion that receives the light from the optical detector and an output portion that couples the light into the optical returner, wherein the input portion and output portion comprise a vertical offset along a longitudinal direction that is orthogonal to the propagation direction, wherein the waveguide walls are tilted at the angle from the vertical offset to cancel crosstalk.
Example 4. The optical device of any of the examples 1-3, wherein the angle of the waveguide walls changes along the propagation direction such that the crosstalk is canceled across a length of the optical coupler.
Example 5. The optical device of any of the examples 1-4, wherein the angle of the waveguide walls changes along the propagation direction due to widths of the first waveguide and the second waveguide changing along a length of the optical coupler.
Example 6. The optical device of any of the examples 1-5, wherein the angle of the waveguide walls changes along the propagation direction due to the gap that tapers along a length of the optical coupler.
Example 7. The optical device of any of the examples 1-6, wherein the gap that separates the first waveguide and the second waveguide tapers toward the optical returner to adiabatically couple light to the optical returner.
Example 8. The optical device of any of the examples 1-7, wherein the angle of the waveguide walls couples cancels crosstalk between a first mode and a second mode of the light.
Example 9. The optical device of any of the examples 1-8, wherein the angle of the waveguide walls permits crosstalk of a first mode and a third mode of the light.
Example 10. The optical device of any of the examples 1-9, wherein the light is coupled into the optical returner from the optical coupler along the propagation direction.
Example 11. The optical device of any of the examples 1-10, wherein the optical returner couplers the returned light into the optical coupler along a counter propagation direction that is parallel to the propagation direction.
Example 12. The optical device of any of the examples 1-11, wherein the optical coupler splits the light such that a portion of the light is coupled from the first waveguide to the optical returner and a remaining portion of the light is coupled from the second waveguide into the optical returner.
Example 13. The optical device of any of the examples 1-12, wherein a surface in the optical device causes optical loss in one or more of: a first mode of the light or a second mode of the light, and wherein crosstalk that is canceled avoids uneven splitting of the light into the portion and the remaining portion.
Example 14. The optical device of any of the examples 1-13, wherein the angle of the waveguide walls compensates for gap variations in the taper of the gap separating the first waveguide and the second waveguide.
Example 15. The optical device of any of the examples 1-14, wherein a taper of the gap and the angle of the waveguide walls cause adiabatic mode evolution to couple the light from the optical detector to the optical returner using the optical coupler.
Example 16. The optical device of any of the examples 1-15, wherein a taper of the gap, the angle of the waveguide walls, and width variations of the waveguide walls cause adiabatic mode evolution to couple the light from the optical detector to the optical returner using the optical coupler.
Example 17. The optical device of any of the examples 1-16, wherein the optical device comprises a photonic integrated circuit, wherein the optical returner comprises an optical loop that is formed in the photonic integrated circuit.
Example 18. The optical device of any of the examples 1-17, wherein the optical device comprises a photonic integrated circuit, wherein the optical returner comprises a reflective surface that reflects the light to form the returned light.
Example 19. The optical device of any of the examples 1-18, wherein the optical device comprises a photonic integrated circuit, wherein the optical returner comprises a Bragg grating to reflect the light to form the returned light.
Example 20. The optical device of any of the examples 1-19, further comprising an additional optical detector, wherein the optical coupler comprises an upper port that is coupled to the optical detector, and wherein the optical coupler comprises a lower port that is coupled to the additional optical detector.
Example 21. The optical device of any of the examples 1-20, wherein control circuitry that is electrically connected to the optical detector generates an electrical signal to indicate detection of one or more photons.
Example 22. The optical device of any of the examples 1-21, wherein the optical device comprises a photonic integrated circuit that comprises the optical detector, the optical returner, and the optical coupler, and the control circuitry.
Example 23. The optical device of any of the examples 1-22, wherein the optical device comprises a photonic integrated circuit that comprises the optical detector, the optical returner, and the optical coupler, and wherein the control circuitry is included in an external electrical circuit that is external to the photonic integrated circuit.
Example 24. The optical device of any of the examples 1-23, wherein the optical detector comprises a plurality of individual photon detection elements.
Example 25. The optical device of any of the examples 1-24, further comprising a plurality of individual photon detection elements, the plurality of individual photon detection elements comprising superconducting elements that lose superconductivity upon detection of a photon.
Example 26. A method comprising: detecting, using an optical detector, light from an optical source; forming returned light from the light using an optical returner; receiving, using an optical coupler, the light from the optical detector, the light being coupled to the optical detector from the optical detector along a propagation direction; and coupling the returned light to the optical detector using the optical coupler, the light being coupled into the optical coupler from the optical detector along the propagation direction, the returned light being coupled into the optical detector, the optical coupler comprising a first waveguide and a second waveguide separated by a gap that tapers towards the optical returner, the first waveguide and second waveguide having waveguide walls that are tilted at an angle to the propagation direction along the optical coupler to cancel crosstalk between the first waveguide and the second waveguide.
Example 27. The method of example 26, wherein the gap tapers at the angle to the propagation direction.
Example 28. The method of any of the examples 26 or 27, wherein the optical coupler comprises an input portion that receives the light from the optical detector and an output portion that couples the light into the optical returner, wherein the input portion and output portion comprise a vertical offset along a longitudinal direction that is orthogonal to the propagation direction, wherein the waveguide walls are tilted at the angle from the vertical offset.
Example 29. The method of any of the examples 26-28, wherein the angle of the waveguide walls changes along the propagation direction such that the crosstalk is canceled across a length of the optical coupler.
Example 30. The method of any of the examples 26-29, wherein the angle of the waveguide walls changes along the propagation direction due to widths of the first waveguide and the second waveguide changing along a length of the optical coupler.

In the foregoing detailed description, the method and apparatus of the present inventive subject matter have been described with reference to specific exemplary embodiments thereof. It will, however, be evident that various modifications and changes may be made thereto without departing from the broader scope of the present inventive subject matter. The present specification and figures are accordingly to be regarded as illustrative rather than restrictive.

What is claimed is:

1. An optical device comprising:
an optical detector to detect light from an optical source;
an optical returner that receives the light and forms returned light; and
an optical coupler that couples the returned light from the optical returner to the optical detector, the light being coupled into the optical coupler from the optical detector along a propagation direction, the returned light being coupled into the optical detector, the optical coupler comprising a first waveguide and a second waveguide separated by a gap that tapers towards the optical returner, the first waveguide and second waveguide having waveguide walls that are tilted at an angle to the propagation direction along the optical coupler to cancel crosstalk between the first waveguide and the second waveguide.

2. The optical device of claim 1, wherein the gap tapers at the angle to the propagation direction.

3. The optical device of claim 1, wherein the optical coupler comprises an input portion that receives the light from the optical detector and an output portion that couples the light into the optical returner, wherein the input portion and output portion comprise a vertical offset along a longitudinal direction that is orthogonal to the propagation direction, wherein the waveguide walls are continuously tilted at the angle from the vertical offset to cancel crosstalk.

4. The optical device of claim 1, wherein the angle of the waveguide walls changes along the propagation direction such that the crosstalk is canceled across a length of the optical coupler.

5. The optical device of claim 1, wherein the angle of the waveguide walls changes along the propagation direction due to widths of the first waveguide and the second waveguide changing along a length of the optical coupler.

6. The optical device of claim 1, wherein the angle of the waveguide walls changes along the propagation direction due to the gap that tapers along a length of the optical coupler.

7. The optical device of claim 1, wherein the gap that separates the first waveguide and the second waveguide tapers toward the optical returner to adiabatically couple light to the optical returner.

8. The optical device of claim 1, wherein the angle of the waveguide walls cancels crosstalk between a first mode and a second mode of the light.

9. The optical device of claim 8, wherein the angle of the waveguide walls permits crosstalk of a first mode and a third mode of the light.

10. The optical device of claim 1, wherein the optical returner couplers the returned light into the optical coupler along a counter propagation direction that is parallel to the propagation direction.

11. The optical device of claim 1, wherein the optical coupler splits the light such that a portion of the light is coupled from the first waveguide to the optical returner and a remaining portion of the light is coupled from the second waveguide into the optical returner.

12. The optical device of claim 11, wherein a surface in the optical device causes optical loss in one or more of: a first mode of the light or a second mode of the light, and wherein crosstalk that is canceled avoids uneven splitting of the light into the portion and the remaining portion.

13. The optical device of claim 12, further comprising a plurality of individual photon detection elements, the plurality of individual photon detection elements comprising superconducting elements that lose superconductivity upon detection of a photon.

14. The optical device of claim 1, wherein a taper of the gap, the angle of the waveguide walls, and width variations of the waveguide walls cause adiabatic mode evolution to couple the light from the optical detector to the optical returner using the optical coupler.

15. The optical device of claim 1, wherein the optical device comprises a photonic integrated circuit, wherein the optical returner comprises an optical loop that is formed in the photonic integrated circuit.

16. A method comprising:
detecting, using an optical detector, light from an optical source;
forming returned light from the light using an optical returner;
receiving, using an optical coupler, the light from the optical detector, the light being coupled to the optical detector from the optical coupler along a propagation direction; and
coupling the returned light to the optical detector using the optical coupler, the light being coupled into the optical coupler from the optical detector along the propagation direction, the returned light being coupled into the optical detector, the optical coupler comprising a first waveguide and a second waveguide separated by a gap that tapers towards the optical returner, the first waveguide and second waveguide having waveguide walls that are tilted at an angle to the propagation direction along the optical coupler to cancel crosstalk between the first waveguide and the second waveguide.

17. The method of claim 16, wherein the gap tapers at the angle to the propagation direction.

18. The method of claim 16, wherein the optical coupler comprises an input portion that receives the light from the optical detector and an output portion that couples the light into the optical returner, wherein the input portion and output portion comprise a vertical offset along a longitudinal direction that is orthogonal to the propagation direction, wherein the waveguide walls are tilted at the angle from the vertical offset.

19. The method of claim 16, wherein the angle of the waveguide walls changes along the propagation direction such that the crosstalk is canceled across a length of the optical coupler.

20. The method of claim 16, wherein the angle of the waveguide walls changes along the propagation direction due to widths of the first waveguide and the second waveguide changing along a length of the optical coupler.
